(19) United States
(12) Patent Application Publication
(10) Pub. No.: US 2016/0378521 A1
(43) Pub. Date: Dec. 29, 2016

(54) AUTOMATED TEST OPTIMIZATION

(71) Applicant: International Business Machines Corporation, Armonk, NY (US)

(72) Inventors: Umit Bektas, Krakow (PL); Pawel T. Januszek, Krakow (PL); Piotr Kania, Krakow (PL); Konrad K. Skibski, Zielonki (PL)

(21) Appl. No.: 14/748,282

(22) Filed: Jun. 24, 2015

(51) Int. Cl. G06F 9/455; G06F 11/36

(52) U.S. Cl. CPC G06F 9/45558; G06F 11/3672; G06F 11/3664; G06F 11/3688; G06F 2009/45562

(57) ABSTRACT

As disclosed herein a method, executed by a computer, includes receiving an indication from a test monitoring operation that an automated test has reached an input checkpoint on a first virtual machine, and receiving a plurality of input responses corresponding to the input checkpoint. The method further includes communicating with a hypervisor to request creation of at least one cloned virtual machine, corresponding to the first virtual machine, to provide a plurality of virtual machines. The method further includes providing each input response of the plurality of input responses to a corresponding virtual machine of the plurality of virtual machines to provide a parallel automated test for the plurality of input responses. A computer system, and a computer program product corresponding to the above method are also disclosed herein.

### BACKGROUND

The present invention relates to software testing, and more particularly to automated software testing.

It is important for computer software products to be tested for potential problems and failures prior to delivering the software product to the users. Testing operations often occur at various phases throughout a delivery cycle, for example, unit test, component verification test, and system test. In software testing, test automation is the use of special software (separate from the software being tested) to control the execution of tests and ultimately compare actual test results with expected results. Test automation may automate some repetitive but necessary tasks in a formalized testing process already in place. Additionally, test automation may provide additional testing that would be difficult to perform manually (e.g., extensive low-level interface verification). Automated testing enables a test organization to easily regression test an application (i.e., rerunning previously completed testing scenarios to re-confirm correct functionality of an application).

### SUMMARY

As disclosed herein a method, executed by a computer, includes receiving an indication from a test monitoring operation that an automated test has reached an input checkpoint on a first virtual machine, and receiving a plurality of input responses corresponding to the input checkpoint. The method further includes communicating with a hypervisor to request creation of at least one cloned virtual machine, corresponding to the first virtual machine, to provide a plurality of virtual machines. The method further includes providing each input response of the plurality of input responses to a corresponding virtual machine of the plurality of virtual machines to provide a parallel automated test for the plurality of input responses. A computer system, and a computer program product corresponding to the above method are also disclosed herein.

### BRIEF DESCRIPTION OF THE DRAWINGS

FIG. 1 is a functional block diagram depicting a computing environment in accordance with at least one embodiment of the present invention;

FIG. 2 is a flowchart depicting a test optimization method, in accordance with at least one embodiment of the present invention;

FIG. 3 depicts an example of a parallel automated testing operation, in accordance with at least one embodiment of the present invention; and

FIG. 4 is a block diagram depicting various components of one embodiment of a computer suitable for executing the methods disclosed herein.

### DETAILED DESCRIPTION

In an effort to provide rapid and flexible response to change, lengthy software product delivery cycles have given way to continuous delivery processes. As a result of the continuous (i.e., shortened) software product delivery cycles, the time available for testing software products has also been reduced. Many continuous delivery processes require a minimum percentage of code coverage (e.g., 80% of all code paths are tested) in unit test and a fully automated component verification test process. To meet the time constraints of the shortened product delivery cycle, and to allow development teams sufficient time to resolve possible coding defects, testing must be performed reliably and quickly.

In an effort to speed up testing operations, various test scenarios may be run in parallel, with each test scenario executing on a separate virtual machine. All testing scenarios start at the same time and progress with different input values or data, thus resulting in varying execution paths through the application. It has been observed that this approach to parallel testing requires a separate virtual machine for each test scenario (e.g., execution path). For large applications this approach to parallel testing may require a very large number of virtual machines and may become cost prohibitive. It has also been observed that using this approach to parallel testing executes common code paths multiple times.

Multiple and repetitive testing of common code may unnecessarily consume additional virtual machines, processors, and disk space. Additionally, if multiple test scenarios discover and report a defect in the common code, resolution of the defect may require additional attention of the development team to confirm that each defect is a duplicated discovery. The embodiments disclosed herein generally address the above-described problems.

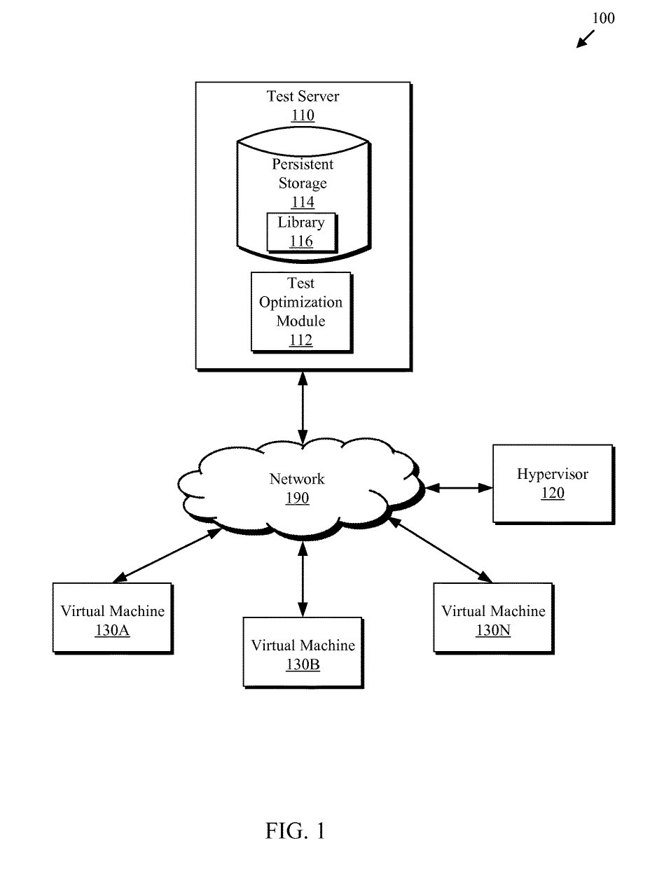

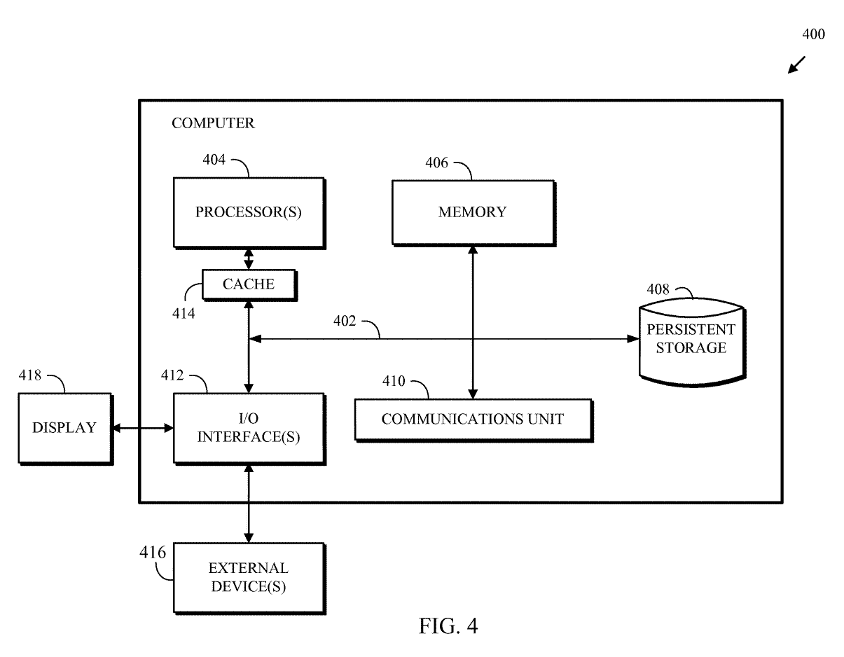

FIG. 1 is a functional block diagram depicting a computing environment 100 in accordance with an embodiment of the present invention. Computing environment 100 includes a test server 110, a hypervisor 120, and virtual machines 130A-N which can be smart phones, tablets, desktop computers, laptop computers, specialized computer servers, or any other computer systems known in the art capable of communicating over network 190. In some embodiments, test server 110, hypervisor 120, and virtual machines 130A-N represent computer systems utilizing clustered computers and components to act as a single pool of seamless resources when accessed through network 190. In general, test server 110, hypervisor 120, and virtual machines 130A-N are representative of any electronic devices, or combination of electronic devices, capable of executing machine-readable program instructions, as described in greater detail with regard to FIG. 4.

As depicted, test server 110 includes test optimization module 112 and persistent storage 114. Test server 110 may store a test library (e.g., library 116), application programs (e.g., applications to be tested), and the like on persistent storage 114. Library 116 may be a collection of software application programming interfaces (APIs), functions, and the like that are required to enable test monitoring operations in an application, and enable the application to communicate with test optimization module 112 during an automated test operation. Additionally, the APIs and functionality provided by library 116 may enable test optimization module 112 to control input and output (I/O) operations during an automated test operation. Test optimization module 112 may be configured to communicate with hypervisor 120 and virtual machines 130A-N, using network 190, while monitoring the automated test operation.

Hypervisor 120 may be computer software, firmware, or hardware, or a combination thereof, that creates and maintains virtual machines 130A-130N. Hypervisor 120 may enable multiple operating systems to share a single hardware host. In some embodiments, hypervisor 120 is a dedicated standalone computer. In other embodiments, hypervisor 120 is a module on test server 110. In other embodiments, virtual machines 130A-130N are created on the same host server. In another embodiment, virtual machines 130A-130N are created on different host servers. Virtual machines 130A-130N may be hardware and software provided as on-demand virtual machines in a dedicated infrastructure, or alternatively, provisioned by shared computing resources such as cloud computing resources.

Persistent storage 114 may be any non-volatile storage media known in the art. For example, persistent storage 114 can be implemented with a tape library, optical library, one or more independent hard disk drives, or multiple hard disk drives in a redundant array of independent disks (RAID). Similarly, data on persistent storage 114 may conform to any suitable storage architecture known in the art, such as a file, a relational database, an object-oriented database, and/or one or more tables.

Test server 110, hypervisor 120, virtual machines 130, and other electronic devices (not shown) communicate over network 190. Network 190 can be, for example, a local area network (LAN), a wide area network (WAN) such as the Internet, or a combination of the two, and include wired, wireless, or fiber optic connections. In general, network 190 can be any combination of connections and protocols that will support communications between test server 110, hypervisor 120 and virtual machines 130A-130N, in accordance with an embodiment of the present invention.

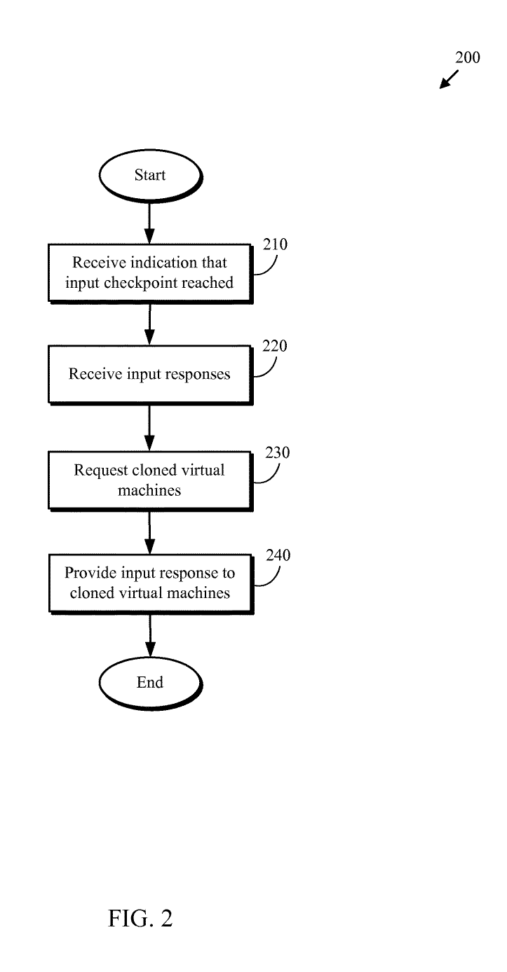

FIG. 2 is a flowchart depicting a test optimization method 200, in accordance with an embodiment of the present invention. As depicted, test optimization method 200 includes receiving (210) an indication that an input checkpoint has been reached, receiving (220) input responses, requesting (230) a cloned virtual machine, and providing (240) an input response to a cloned virtual machine. Test optimization method 200 enables a test optimization module (e.g. test optimization module 112) to manage the automated test corresponding to the input checkpoint, and subsequently optimize the automated test.

Receiving (210) an indication that an input checkpoint has been reached may include test optimization module 112 receiving an indication from an automated test operation that an input checkpoint has been reached. In some embodiments, upon encountering an indication, test optimization module 112 freezes the current virtual machine, suspending any further processing by the application. In other embodiments, the current virtual machine remains active, permitting execution to proceed while the input checkpoint is processed.

The indication that an input checkpoint has been reached may be provided by an application that has enabled test monitoring operations using APIs and functions from library 116. In some embodiments, test optimization module 112 is implemented as part of an event driven system that is continually monitoring (e.g., listening) for specific events (e.g., messages) that indicate an automated test has reached an input checkpoint. In other embodiments, the indication is received as a direct call (e.g., program call, or function call) to test optimization module 112.

Input checkpoints may be manually inserted into the application using APIs and functionality provided by library 116. In some embodiments, the location of an input checkpoint within an application is any instance within the application that requires interaction from an outside source. In other embodiments, the location of an input checkpoint within an application is any decision point within the application. Examples of instances that may require input checkpoints include, but are not limited to, (i) user input from a keyboard or mouse; (ii) input read from a file; (iii) input from system resources such as the system registry; and (iv) results from other commands or applications. In some embodiments, an option configured at compile time enables the APIs and functionality provided by library 116. In other embodiments, software configuration (e.g., flags) maintained as environment variables enables the APIs and functionality provided by library 116.

Receiving (220) input responses may include test optimization module 112 receiving a collection of possible responses corresponding to an input checkpoint. The responses may represent input from any input device, a file, a system service, another applications, or the like. In some embodiments, the collection includes all possible valid responses as well as responses that exercise error paths in the code. In other embodiments, the collection includes only responses that result in following unique code execution paths. In one embodiment, test optimization module 112 receives a response file that was retrieved from persistent storage 114. The response file may contain input responses corresponding to each input checkpoint associated with an automated test operation. In another embodiment, test optimization module 112 receives input responses corresponding to an input checkpoint as part of the indication that an input checkpoint has been reached.

Requesting (230) a cloned virtual machine may include test optimization module 112 taking a snapshot of the current virtual machine. Test optimization module 112 may then communicate with a hypervisor (e.g., hypervisor 120) to request one or more cloned virtual machines be provisioned using the snapshot as the template for the cloned virtual machines. In some embodiments, test optimization module 112 requests one cloned virtual machine for each input response corresponding to the current input checkpoint. In other embodiments, test optimization module 112 reuses the current virtual machine, and the number of cloned virtual machines is one less than the number of input responses corresponding to the current input checkpoint. If the first virtual machine is reused, for purposes of this example, the first virtual machine is considered to be one of the cloned virtual machines.

Providing (240) an input response to a cloned virtual machine may include providing the application on each of the cloned virtual machines with one of the responses from the list of input responses corresponding to the current input checkpoint. In some embodiments, test optimization module 112 provides an input response to each of the applications on the cloned virtual machines. In other embodiments, test optimization module 112 provides the input responses to hypervisor 120, and hypervisor 120 provides an input response to the application as part of the virtual machine cloning operation. The automated testing operation may commence once the cloned virtual machine is fully provisioned and the application is provided with an input response.

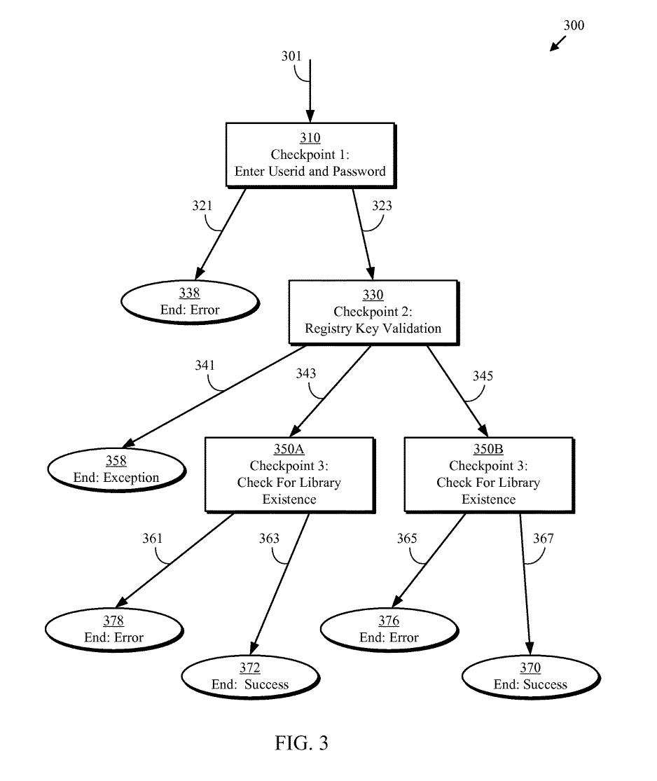

FIG. 3 depicts an example 300 of a parallel automated testing operation, in accordance with an embodiment of the present invention. Example 300 depicts a parallel automated test operation on an application in which there are three input checkpoints (310, 330, and 350) enabled. Each connector (301, 321, 323, 341, 343, 345, 361, 363, 365, and 367) in example 300 represents a virtual machine performing automated test processing on one execution path within the application. Connector 301 represents the initialization of an automated test running on a single virtual machine. In some embodiments, test optimization module 112 communicates with hypervisor 120 to request the creation of a first virtual machine (e.g., 301), and subsequently test optimization module 112 invokes the automated test on virtual machine 301.

The first input checkpoint 310 is reached when the application requires authentication in the form of a userid and password. At this point test optimization module 112 receives two input responses (e.g. one valid userid/password combination and one invalid userid/password combination). Test optimization module 112 provides a snapshot of the current virtual machine and the two responses to hypervisor 120. Hypervisor 120 produces two virtual machine clones (321 and 323) using the snapshot as a template. Additionally, hypervisor 120 provides virtual machine clone 321 with the invalid input response (i.e., the invalid userid/password) and provides virtual machine 313 with the valid input response (i.e., the valid userid/password). In some embodiments, hypervisor 120 creates one virtual machine clone and re-uses the existing virtual machine. In other embodiments of the current example, hypervisor 120 creates two virtual machine clones, and test optimization module 112 terminates virtual machine 301 which releases and returns resources being consumed by virtual machine 301.

As processing continues, virtual machine 321 exits the automated test with an error 338 and an appropriate message due to an invalid userid and password. Virtual machine 323 proceed until a second input checkpoint 330 (a registry key validation) is reached. Similar to input checkpoint 320, test optimization module 112 provides to hypervisor 120 a snapshot of the current virtual machine and three input responses corresponding to input checkpoint 330: (i) a key that does not exist—provided to cloned virtual machine 341; (ii) a key with expected content—provided to cloned virtual machine 343; and (iii) a key with unexpected content—provided to cloned virtual machine 345.

As processing continues, virtual machine 341 exits the automated test with an exception 358 due to a missing registry key. Virtual machines 343 and 345 each proceed until they reach a third input checkpoint 350A and 350B (checking for library existence). Input checkpoints 350A and 350B each represent the same location in the code (i.e., input checkpoint 350), however, virtual machines 343 and 353 arrived at input checkpoint 350 via different code execution paths. Input checkpoint 350 handles processing at input checkpoint in the same manner as input checkpoints 310 and 330. Although input checkpoint 350A and 350B are different execution paths, each may receive the same input responses during the input checkpoint processing. There are two input responses corresponding to input checkpoint 350: (i) library does not exist—provided to cloned virtual machines 361 and 365; and (ii) library does exist—provided to cloned virtual machines 363 and 367.

Virtual machine 361 exits the automated test with an error 378 and an appropriate message due to a missing library. Virtual machine 363 exits the automated test with success 272. Virtual machine 365 exits the automated test with an error 376 and an appropriate message due to a missing library. Virtual machine 367 exits the automated test with success 270.

In this example, six execution paths were tested, without duplicate execution or testing of the user authentication operation (input checkpoint 310) or registry key validation operation (input checkpoint 330). Additionally, while testing 6 execution paths in a parallel automated test, there were at most four virtual machines in use at one time.

FIG. 4 depicts a block diagram of components of a computer system 400, which is an example of systems such as test server 110, hypervisor 120, and virtual machines 130A-130N within computing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Test server 110, hypervisor 120, and virtual machines 130A-130N include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., test optimization method 200 are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of test server 110, hypervisor 120, and virtual machines 130A-130N. In these examples, communications unit 410 includes one or more network interface cards. Communications unit 410 may provide communications through the use of either or both physical and wireless communications links. Program instructions and data used to practice embodiments of test optimization method 200 may be downloaded to persistent storage 408 through communications unit 410.

I/O interface(s) 412 allows for input and output of data with other devices that may be connected to each computer system. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving an indication from a test monitoring operation that an automated test has reached an input checkpoint on a first virtual machine;
receiving a plurality of input responses corresponding to the input checkpoint;
communicating with a hypervisor to request creation of at least one cloned virtual machine corresponding to the first virtual machine to provide a plurality of virtual machines; and
providing each input response of the plurality of input responses to a corresponding virtual machine of the plurality of virtual machines to enable a parallel automated test for the plurality of input responses.

2. The method of claim 1, further comprising, communicating with the hypervisor to request creation of the first virtual machine, and invoking the automated test on the first virtual machine.

3. The method of claim 1, wherein the first virtual machine is reused after the automated test has reached the input checkpoint.

4. The method of claim 1, wherein the first virtual machine is terminated after the automated test has reached the input checkpoint.

5. The method of claim 1, wherein a response file provides the plurality of input responses corresponding to the input checkpoint.

6. The method of claim 1, wherein the test monitoring operation is enabled using software configuration.

7. The method of claim 1, wherein encountering the input checkpoint freezes the first virtual machine and suspends any further execution by the first virtual machine.

8. A computer program product comprising:
one or more computer readable storage media and program instructions stored on the one or more computer readable storage media, the program instructions comprising instructions to:
receive an indication from a test monitoring operation that an automated test has reached an input checkpoint on a first virtual machine;
receive a plurality of input responses corresponding to the input checkpoint;
communicate with a hypervisor to request creation of at least one cloned virtual machine corresponding to the first virtual machine to provide a plurality of virtual machines; and
provide each input response of the plurality of input responses to a corresponding virtual machine of the plurality of virtual machines to enable a parallel automated test for the plurality of input responses.

9. The computer program product of claim 8, wherein the program instructions include instructions to communicate with the hypervisor to request creation of the first virtual machine, and invoke the automated test on the first virtual machine.

10. The computer program product of claim 8, wherein the first virtual machine is reused after the automated test has reached the input checkpoint.

11. The computer program product of claim 8, wherein the first virtual machine is terminated after the automated test has reached the input checkpoint.

12. The computer program product of claim 8, wherein a response file provides the plurality of input responses corresponding to the input checkpoint.

13. The computer program product of claim 8, wherein the test monitoring operation is enabled using software configuration.

14. The computer program product of claim 8, wherein the instructions to encounter the input checkpoint include instructions to freeze the first virtual machine and suspend any further execution by the first virtual machine.

15. A computer system comprising:
one or more computer processors;
one or more computer readable storage media;
program instructions stored on the computer readable storage media for execution by at least one of the computer processors, the program instructions comprising instructions to:
receive an indication from a test monitoring operation that an automated test has reached an input checkpoint on a first virtual machine;
receive a plurality of input responses corresponding to the input checkpoint;
communicate with a hypervisor to request creation of at least one cloned virtual machine corresponding to the first virtual machine to provide a plurality of virtual machines; and
provide each input response of the plurality of input responses to a corresponding virtual machine of the plurality of virtual machines to enable a parallel automated test for the plurality of input responses.

16. The computer system of claim 15, wherein the program instructions include instructions to communicate with the hypervisor to request creation of the first virtual machine, and invoke the automated test on the first virtual machine.

17. The computer system of claim 15, wherein the first virtual machine is reused after the automated test has reached the input checkpoint.

18. The computer system of claim 15, wherein the first virtual machine is terminated after the automated test has reached the input checkpoint.

19. The computer system of claim 15, wherein a response file provides the plurality of input responses corresponding to the input checkpoint.

20. The computer system of claim 15, wherein the test monitoring operation is enabled using software configuration.
